(19) United States
(12) Patent Application Publication
(10) Pub. No.: US 2014/0288207 A1
(43) Pub. Date: Sep. 25, 2014

(54) CURABLE COMPOSITION HAVING CONSTITUENTS WHICH LIBERATE ALCOHOL DURING CURING

(71) Applicant: Stephan Roessing, Oberhausen (DE)

(72) Inventors: Bastian Matthias Brugger, Oberhausen (DE); Melanie Roessing, Oberhausen (DE); Sabine Giessler-Blank, Dortmund (DE); Beatrix Vom Bruch, Herten (DE)

(21) Appl. No.: 14/006,229

(22) PCT Filed: Mar. 21, 2012
(86) PCT No.: PCT/EP12/54942

§ 371 Date: Nov. 14, 2013

(30) Foreign Application Priority Data
Mar. 29, 2011 (DE) 10 2011 006 313.7

(51) Int. Cl. C08G 65/22; C09K 3/10; C09J 171/02

(52) U.S. Cl. CPC C08G 65/22; C09J 171/02; C09K 3/1018
USPC 523/122; 528/27; 524/868; 524/714; 524/730

(57) ABSTRACT

The present invention relates to a curable composition comprising at least one nonexclusively terminally alkoxysilylated alkoxylation product and at least one curing catalyst, which is characterized in that the nonexclusively terminally alkoxysilylated alkoxylation product is a prepolymer having an average of between 2.0 and 8.0 ethoxysilyl functions per prepolymer, and to sealants and/or adhesives comprising this curable composition, and to the use of the curable composition or the sealant and adhesive.

The present application claims priority from PCT Patent Application No. PCT/EP2012/054942 filed on Mar. 21, 2012, which claims priority from German Patent Application No. DE 10 2011 006 313.7 filed on Mar. 29, 2011, the disclosures of which are incorporated herein by reference in their entirety.

### FIELD OF THE INVENTION

The present invention relates to a curable composition comprising at least one nonexclusively terminally alkoxysilylated alkoxylation product and at least one curing catalyst, which is characterized in that the nonexclusively terminally alkoxysilylated alkoxylation product is a prepolymer having an average of between 2.0 and 8.0 ethoxysilyl functions per prepolymer, and to sealants and/or adhesives comprising this curable composition, and to the use of the curable composition or the sealant and adhesive.

It is noted that citation or identification of any document in this application is not an admission that such document is available as prior art to the present invention.

Alkoxysilane-terminated polymers have already been used for some time as a basis for adhesives and sealants with a wide application spectrum. These include the polyether-based products sold under the MS-Polymer® name from Kaneka, and likewise the silyl-modified polyurethanes from various other manufacturers, for example the Desmoseal® S products from Bayer. The underlying chemistry leads, in these products, to alkoxysilyl functions exclusively at the chain end of the polymers; the introduction of more than one alkoxysilyl group per chain end is impossible. The alkoxysilane functions used are usually methyldimethoxysilanes, and less commonly trimethoxysilanes. When ethoxysilanes which, in contrast to methoxysilanes, eliminate ethanol rather than methanol in the course of curing are used, the curing rate is frequently insufficient, and so industrial and commercial use as a sealant and/or adhesive is impossible. The document “Geniosil—Organofunktionelle Silane von WACKER” [Geniosil—Organofunctional silanes from WACKER) (http://www.wacker.com/cms/media/publications/downloads/6085_DE.pdf, accessed online on 20.02.2011) describes, on page 11, the relationship between the type of alkoxysilane function and the skin formation time, which describes the superficial commencement of curing. It is stated here that, given the same chemical environment of the silane function, triethoxysilanes compared to trimethoxysilanes require more than 4 times longer for skin formation to set in (>2 hours compared to 25 minutes). This massive difference in reactivity consequently affects not only the curing of the surface, but also in depth curing, more particularly within the first 24 hours. Propoxysilanes or isopropoxysilanes do not have sufficient reactivity for use in room temperature curing adhesive or sealant formulations.

If, nevertheless, base polymers which release ethanol in the course of curing are used, methoxy-functional silanes or methoxyaminosilanes are additionally used for chemical drying and/or to promote adhesion to substrates, and so methanol is again released in the course of curing of the complete formulation. A very typical representative for chemical drying agents is vinyltrimethoxysilane; among the adhesion promoters, derivatives of the aminopropyltrimethoxysilanes are frequently encountered.

The release of methanol is problematic with regard to the harmful effect of methanol. Especially in interiors or in poorly ventilated areas, methanol, being a neurotoxin, is a matter of concern. A lower risk emanates here from ethanol. It would therefore be desirable to use adhesives and/or sealants which eliminate exclusively ethanol and no methanol in the course of curing.

It was therefore an object of the present invention to provide curable compositions which release ethanol and only small amounts of, or preferably no, methanol in the course of curing and possess curing characteristics which enable industrial and commercial use as an adhesive and/or sealant.

This object is achieved by the use of a specific selection of prepolymers presented in DE 10 2010 038768 and DE 10 2010 038774 which release exclusively ethanol in the course of curing, and if appropriate by use of specific drying agents and/or adhesion promoters.

It is noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right to disclaim, and hereby disclose a disclaimer of, any previously described product, method of making the product, or process of using the product.

### SUMMARY OF THE INVENTION

The present invention provides a curable composition comprising at least one nonexelusively terminally alkoxysilylated alkoxylation product, at least one curing catalyst, characterized in that the nonexclusively terminally alkoxysilylated alkoxylation product is a prepolymer having an average of between 2.0 and 8.0 ethoxysilyl functions, preferably di- and/or trithoxysilyl functions, per prepolymer.

The present invention further provides the use of the inventive compositions for reinforcement, levelling, modification, adhesive bonding, sealing and/or coating of substrates.

The inventive curable composition has the advantage that, in the course of moisture-induced curing, the weight ratio of ethanol released to the sum of the other alcohols released, more particularly to methanol released, is at least 10:1, preferably at least 20:1 and more preferably 50:1 to 200:1, and most preferably exclusively ethanol is released.

A further advantage of the inventive composition is that the curing is comparable to the curing rate of compositions which are based on methoxysilyl groups which are available on the market.

### DETAILED DESCRIPTION OF EMBODIMENTS

It is to be understood that the descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

The inventive compositions, the process for production thereof and the use thereof are described by way of example hereinafter, without any intention that the invention be restricted to these illustrative embodiments. If ranges, generally formulae or compound classes are specified hereinafter, these shall include not only the corresponding ranges or groups of compounds mentioned explicitly, but also all sub-ranges and sub-groups of compounds which can be obtained by selection of individual values (ranges) or compounds. If documents are cited in the context of the present description, the content thereof, especially based on the matter referred to, shall form a full part of the disclosure-content of the present invention. If figures are reported in percent hereinafter, these are, unless stated otherwise, figures in % by weight. If averages are reported hereinafter, these are, unless stated otherwise, the number average. If substance properties, for example viscosities or the like, are reported hereinafter, these are, unless stated otherwise, the substance properties measured at 25° C. and, if appropriate, a shear rate of 10 s⁻¹.

In the context of the present invention, the term “alkoxylation products” or “polyethers” encompasses polyethers, polyetherols, polyether alcohols, polyether esters, but also polyether carbonates, which may be used synonymously to one another. It is not obligatory that the expression “poly” must imply that there are a multitude of ether functionalities or alcohol functionalities in the molecule or polymer. Instead, this indicates merely that at least repeat units of individual monomer units or else compositions having a higher molar mass and additionally also a certain polydispersity are present.

The word fragment “poly” in the context of this invention encompasses not only exclusively compounds having at least 3 repeat units of one or more monomers in the molecule, but more particularly also those compositions of compounds which have a molecular weight distribution and have a mean molecular weight of at least 200 g/mol. This definition takes account of the fact that it is customary in the field of industry in question to refer to such compounds already as polymers, even if they do not appear to meet a polymer definition analogous to OECD or REACH guidelines.

The inventive curable composition comprising at least one nonexclusively terminally alkoxysilylated alkoxylation product A and at least one curing catalyst has the feature that the nonexclusively terminally alkoxysilylated alkoxylation product is a prepolymer having an average of between 2.0 and 8.0, more preferably between 2.25 and 6.5 and especially preferably 2.5 to 5.0 ethoxysilyl functions per prepolymer.

It may be advantageous when the nonexclusively terminally alkoxysilylated alkoxylation product has exclusively ethoxysilyl groups as alkoxysilyl groups. The inventive composition preferably comprises alkoxylation products A in which all ethoxysilyl groups are triethoxysilyl groups. Particularly preferred compositions comprise alkoxylation products A which have exclusively triethoxysilyl groups as alkoxysilyl groups.

The nonexclusively terminally alkoxysilylated alkoxylation products A present in the inventive compositions can be prepared, for example, by a process as described in EP 2093244 (US 2010/0041910), DE 10 2010 038768 or DE 10 2010 038774.

According to EP 2093244, the disclosure of which in relation to the structures disclosed therein, formulae I, II, III and formula VIII, is hereby introduced completely as part of this description, it was possible for the first time to prepare alkoxylation products bearing alkoxysilyl groups, which, in contrast to the prior art known until then, have alkoxysilyl groups in blockwise or random distribution along the polyether chain, and not just localized at the termini of the chain. In addition, these compounds are notable for a terminal OH group related to the reaction.

The presence of the OH group and the hydrolysis-sensitive alkoxysilyl groups in a molecule is the origin of the intrinsic reactivity of the compounds and easy crosslinkability to form three-dimensional polymeric networks. However, tests have also shown that the reactivity of the OH group may be too high to achieve a storage stability sufficient for the demands on 1-component adhesive and sealant formulations. Storage stability is understood in this context to mean stability against crosslinking or gelation of the finished, catalyst-containing formulation in the course of storage in a thick-wall cartridge customary on the market. The compounds mentioned include especially those of the formula (I).

The different monomer units of the alkoxylation products of the formula (I), both of the fragments with the indices d to j and of any polyoxyalkylene chain present in the substituent R¹, may be present in blockwise structure with one another, or else be subject to a random distribution.

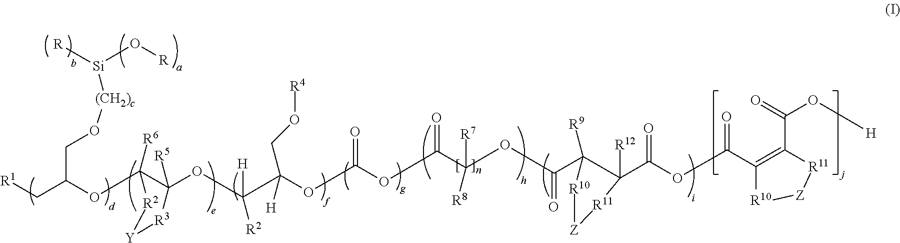

where
the indices are each as defined in the disclosure of EP 2 093 244.

The chain length of the polyether radicals which have alkoxy, arylalkoxy or alkylarylalkoxy groups and are useable as the starter compound is as desired. The polyether, alkoxy, arylalkoxy or alkylarylalkoxy group contains preferably 1 to 1500 carbon atoms, more preferably 2 to 300 carbon atoms, especially 2 to 100 carbon atoms.

The compounds thus prepared give the synthetic freedom to select between polyoxyalkylene compounds having alkoxysilyl groups and containing alkoxysilyl functions in terminal form, or in isolated form, in cumulated blocks, or else randomly distributed in the polyoxyalkylene chain.

The alkoxylation products of the formula (I) have the feature that they can be produced in a controlled and reproducible manner in terms of structure and molar mass. The sequence of the monomer units can be varied within wide limits. Epoxide monomers can be incorporated into the polymer chain in any blockwise sequence or randomly. The sequence of the fragments inserted into the forming polymer chain by the reaction with ring opening of the reaction components is freely permutable, with the restriction that cyclic anhydrides and carbon dioxide are present randomly inserted, i.e. not in homologous blocks, in the polyether structure.

The various fragments of the siloxane chains shown in the formula (I) may be randomly distributed. Random distributions may be in blockwise form with any number of blocks and any sequence, or be subject to a randomized distribution; they may also have an alternating structure or else form a gradient over the chain; more particularly, they can also form all mixed forms.

Alkoxylation products of the formula (I) have chains which are substituted by alkoxysilyl groups and are highly functionalized in a controlled manner by the selection of fragments d to j, corresponding to the fragments inserted into the polymer chain by the reaction with ring opening of the reaction components, and can thus be tailored for different fields of use.

The indices reproduced in the formulae shown here and the value ranges of the indices reported are therefore understood to be the mean values of the possible statistical distribution of the structures actually present and/or mixtures thereof. This also applies to structural formulae reproduced exactly as such, as for example to formula (I) and/or (III).

According to the epoxide-functional alkoxysilane used and any further monomers used, and possibly also carbon dioxide, it is possible to obtain ester- or carbonate-modified silyl polyethers. The alkoxysilyl unit in the compound of the formula (I) is preferably a trialkoxysilyl unit.

As ²⁹Si NMR and GPC analyses show, the process-related presence of chain-terminal OH groups results in the possibility of transesterification reactions on the silicon atom both during the DMC-catalysed preparation and, for example, in a downstream process step. In a formal sense, the alkyl radical R bonded to the silicon via an oxygen atom is exchanged for a long-chain modified alkoxysilyl polymer radical. Bimodal and also multimodal GPC curves demonstrate that the alkoxylation products, as well as the untransesterified species, as shown in formula (I), comprise those with double the molar mass, in some cases three times the molar mass or even several times the molar mass. Formula (I) therefore represents the complex chemical reality only in simplified form.

Therefore, the alkoxylation products are mixtures which also contain compounds in which the sum of the indices (a) plus (b) in formula (I) has a statistical average of less than 3, since some of the OR groups can be replaced by silyl polyether groups. The compositions thus contain species which are formed on the silicon atom with elimination of R—OH and condensation reaction with the reactive OH group of a further molecule of the formula (I). This reaction can proceed several times until, for example, all RO groups on the silicon have been exchanged for further molecules of the formula (I). The presence of more than one signal in the typical ²⁹Si NMR spectra of these compounds supports the occurrence of silyl groups with different substitution patterns.

The values and preferred ranges reported for the indices (a) to (j) of the compounds of the formula (I) should thus also be understood merely as averages over the different species which cannot be detected individually. The variety of chemical structures and molar masses is also reflected in the broad molar mass distributions of M_{w}/Mₙ of usually ≧1.5, which is typical of alkoxylation products of the formula (I) and completely unusual for conventional DMC-based polyethers.

In the prior art methods, it is possible to form only silyl group-terminated prepolymers. The alkoxylation products used in accordance with the invention as a reactive component differ from oligomers or polymers modified by conventional methods in that the controlled chain buildup and the variable insertion of functional groups in a blockwise but also isolated manner forms structures which both have silyl functionalization in scattered form or in blockwise distribution over the entire chain and moreover can additionally but not absolutely necessarily also bear a silyl functionalization on the termini.

A special feature inextricably associated with the process detailed in EP 2 093 244 for alkoxylation of epoxy-functional alkoxysilanes is the fact that an OH functionality is always present on the termini, having originated from the epoxide ring opening of the last epoxide monomer in each case with linkage to the OH-functional end of the growing chain.

In patent applications DE 10 2010 038768 and DE 10 2010 038774, which were yet to be published at the priority date of the present application, the aim was to lower the reactivity of the OH group of alkoxylation products of the formula (I) which are terminated by hydroxyl groups and do not bear exclusively terminal alkoxysilyl groups.

It has been shown that the reduction in the reactivity of the OH groups can massively improve the storage stability and also the elongation at break of the cured/polymerized alkoxysilylated alkoxylation product.

The introduction of end capping of the hydroxyl group at the chain end of the prepolymer has achieved this.

Alkoxylation products A present with preference in the inventive composition are prepolymers of the general formula (III)

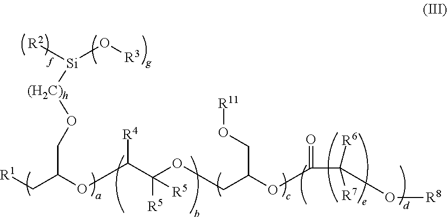

where
R¹=a mono- to hexafunctional saturated or unsaturated, linear or branched organic radical attached via an oxygen atom, preferably of the alkoxy, arylalkoxy or alkylarylalkoxy group type, in which the carbon chain may be interrupted by oxygen atoms and may also bear pendant substituents containing alkoxysilyl groups or is substituted directly by alkoxysilyl groups, selected from the group of the polyoxyalkylene radicals, polyether radicals, a polyetheralkoxy radical or is a singly or multiply fused phenolic group, or may be derived from a mono- or polyhydroxylated alcohol, polyetherol, polyesterol, siloxane, perfluorinated polyetherol, (poly)urethane or sugar,
R²=an alkyl group having 1 to 2 carbon atoms,
R³=an alkyl group having 2 carbon atoms,
R⁴=independently a hydrogen radical or an alkyl group having 1 to 8 carbon atoms,
R⁵=independently a hydrogen radical, an alkyl group having 1 to 20 carbon atoms, an aryl or alkaryl group,
R⁶ and R⁷=independently as R⁵,
R⁸=a trialkylsilyl end block or a urethane end block or ester end block which has originated from the reaction of a terminal alcohol function with hydroxyl-reactive compounds containing the R⁸ radical, especially an end group of the formula (IV)

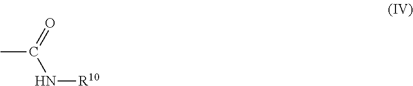

where
R¹⁰=independently a linear or branched, saturated or unsaturated, optionally further-substituted alkyl group having 1 to 30 carbon atoms, an aryl or alkaryl group, preferably methyl, ethyl, propyl, isopropyl, butyl, isobutyl, octyl, decyl, dodecyl, phenyl, tolyl, benzyl, isopropylphenyl or stearyl group, more preferably methyl, ethyl, propyl, isopropyl, butyl, phenyl, tolyl, isopropylphenyl or stearyl group, or an -A(T)ₓ group where A=hydrocarbyl radical, preferably having 2 to 16 carbon atoms, which may optionally be substituted by halogen atoms, x=1 to 4, preferably 1 or 2, more preferably 1, and T is the same or different and is —N═C═O, —NH—C(O)—X, where X=O—R¹² or NH—R¹², where R¹² is the same or different and is a hydrocarbyl radical which may be interrupted by heteroatoms, preferably a saturated or unsaturated hydrocarbyl radical, preferably saturated hydrocarbyl radical having no heteroatoms, where the hydrocarbyl radical has preferably from 1 to 30, more preferably from 2 to 18 and especially preferably from 3 to 10 carbon atoms, and especially a methyl, ethyl, propyl or butyl radical, preferably a butyl radical, or X is a polyether radical, preferably a polyether radical with a molar mass between 49 g/mol and 1999 g/mol, more preferably between 99 g/mol and 1199 g/mol, and more preferably a butanol-started propylene oxide polyether radical with a molar mass of 300 to 500 g/mol, or X is a radical of the formula (IIIa)

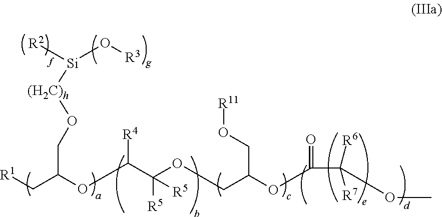

where R¹ to R⁷, R¹¹ and a to h are each as defined for formula III, where X is preferably not a radical of the formula IIIa,
a=0 to 1000, preferably 0 to 50, more preferably greater than 0 to 10, with the proviso that a must be greater than or equal to 2 when R¹ does not bear any substituents with alkoxysilyl groups or is not itself directly substituted by alkoxysilyl groups, especially by ethoxysilyl groups, more preferably triethoxysilyl groups,
b=0 to 1000, preferably 1 to 800, more preferably 30 to 500 and especially 80 to 300,
c=independently as b,
d=independently as b,
with the proviso that the sum of a, b, c and d is at least 3,
with the proviso that the groups with the indices a, b, c and d are freely permutable over the molecule chain, but at least more than one group with the index a is not arranged terminally in the polymer chain,
e=1 to 10,
g+f=3 and g is at least equal to 2,
h=2, 3, 4, and with the proviso that
the different monomer units both of the fragments with the indices a, b, c, and d with one another and within the polyoxyalkylene chain of the R¹ substituent may be in blockwise structure, or else may be subject to a random distribution, and are additionally freely permutable with one another.

The mean molar masses M_{w} of the alkoxylation products A, especially of the prepolymers of the formula (III), are preferably between 8000 and 40 000 g/mol, more preferably between 10 000 and 20 000 g/mol. The compounds of the formula (III) are preferably liquid at room temperature.

It may be advantageous when the inventive composition comprises only prepolymers of the formula (III) where R⁸ is as defined above and no prepolymers of the formula (III) in which R⁸ is hydrogen.

It may, however, also be advantageous when the inventive composition, as well as prepolymers of the formula (III) where R⁸ is as defined above, also comprises those prepolymers of the formula (III) in which R⁸ is hydrogen. When both types of prepolymers are present in the inventive composition, the mass ratio (ratio of parts by mass) of prepolymers of the formula (III) where R⁸ is as defined above to prepolymers of the formula (III) in which R⁸ is hydrogen is from 100:>0 to 10:90, preferably between 95:5 and 15:85 and more preferably between 80:20 and 30:70. The prepolymers of the formula (III) in which R⁸ is hydrogen preferably also have, as alkoxysilyl groups, predominantly or exclusively, preferably exclusively, ethoxysilyl groups, more preferably triethoxysilyl groups.

The R¹ radical preferably originates from a compound which contains hydroxyl groups and is of the formula (II)

R¹—(H) (II)

where R¹=R^{X}—O— and R^{x}=attached mono- to hexa-functional saturated or unsaturated, linear or branched organic radical, preferably of the alkoxy, arylalkoxy or alkylarylalkoxy group type, in which the carbon chain may be interrupted by oxygen atoms and may also bear pendant substituents containing alkoxysilyl groups or is substituted directly by alkoxysilyl groups, where the alkoxysilyl groups must not occur in terminal positions, selected from the group of the polyoxyalkylene radicals, polyether radicals, a polyetheralkoxy radical or is a singly or multiply fused phenolic group, or may be derived from a mono- or polyhydroxylated alcohol, polyetherol, polyesterol, siloxane, perfluorinated polyetherol, (poly)urethane or sorbitol.

The compound of the formula (II) is preferably selected from the group of the alcohols, polyetherols and phenols. The starter compound used is preferably a mono- or polyhydric polyether alcohol or alcohol, or else water. It may be advantageous when compounds of the formula (II) whose R¹ radical has one or more alkoxylsilyl groups, preferably ethoxysilyl groups and more preferably triethoxysilyl groups, are used.

Advantageously, low molecular weight polyetherols having 1 to 8 hydroxyl groups and molar masses of 50 to 2000 g/mol, which have in turn been prepared beforehand by DMC-catalysed alkoxylation, are used as starter compounds containing the R¹ radical.

Examples of the compounds containing hydroxyl groups include water, allyl alcohol, butanol, octanol, dodecanol, stearyl alcohol, 2-ethyihexanol, cyclohexanol, benzyl alcohol, ethylene glycol, propylene glycol, di-, tri- and polyethylene glycol, 1,2-propylene glycol, di- and polypropylene glycol, 1,4-butanediol, 1,6-hexanediol, trimethylolpropane, glycerol, pentaerythritol, sorbitol, cellulose sugar, lignin, or else further compounds which bear hydroxyl groups and are based on natural substances.

Where reference is made to natural substances in the context of this invention, for example sorbitol, what is meant thereby is in principle all isomers, preference being given to the naturally occurring isomers in each case, i.e. in the case mentioned here D-sorbitol, (2R,3R,4R,5S)-hexane-1,2,3,4,5,6-hexaol (CAS RN 50-70-4). For a definition of natural substances, reference is made to the contents of the “Dictionary of Natural Products”, Chapman and Hall/CRC Press, Taylor and Francis Group, for example in the 2011 online version: http://dnp.chemnetbase.com/.

As well as compounds with aliphatic and cycloaliphatic OH groups, suitable compounds are any having 1 to 20 phenolic OH functions. Examples of these include phenol, alkyl- and arylphenols, bisphenol A and novolacs.

The different monomer units both of the fragments of the compounds of the formula (III) with the indices a, b, c, and d and of any polyoxyalkylene chain present in the substituent R¹ may be in blockwise form with one another, or else be subject to a random distribution, and may additionally be freely permuted with one another. The sequence of the monomer units in the polymer formed depends solely on the metering sequence and the reactivity of the underlying molecules.

The proportion of the alkoxylation products A, which has an average of between 2.0 and 8.0 ethoxysilyl functions per polymer backbone, in the inventive composition is preferably from 10 to less than 80% by weight, more preferably from 18 to 65% by weight and especially preferably from 21% by weight to 64% by weight.

The curing catalysts used (for the crosslinking or polymerization of the inventive composition or the chemical fixing thereof on particle surfaces or macroscopic surfaces) may be the catalysts used customarily for hydrolysis and condensation of alkoxysilanes. The curing catalysts used are preferably organic tin compounds, for example dibutyltin dilaurate, dioctyltin dilaurate, dibutyltin diacetylacetonate, dibutyltin diacetate, dibutyltin dioctoate or dioctyltin diacetylacetonate, preferably dibutyltin diacetylacetonate or dioctyltin diacetylacetonate, more preferably dioctyltin diacetylacetonate. Preference is given to those catalysts and formulations which release less than 0.5% by weight of their mass in methanol on contact with moisture within the first 48 hours, particular preference being given to catalysts which release no methanol on contact with moisture.

The proportion of the curing catalysts in the inventive composition is preferably from 0.1% by weight to 5.00% by weight, more preferably from 0.15% by weight to 2.00% by weight and especially preferably from 0.2 to 0.75% by weight, based on the overall composition.

The inventive composition may comprise further additives selected from the group of the plasticizers, fillers, solvents, adhesion promoters, additives for adjusting the flow characteristics, what are called rheology additives and drying agents, especially chemical moisture drying agents.

The inventive composition preferably comprises one or more adhesion promoters and/or one or more drying agents, especially chemical moisture drying agents. The adhesion promoters present in the inventive composition may be the adhesion promoters known from the prior art, especially aminosilanes. Of particular interest for sealant and adhesive applications are those aminosilanes whose silane function is dimethoxy- or trimethoxysilane-functionalized. Known products of this kind are 3-aminopropyltrimethoxysilane (Geniosil® GF 96 (Wacker) or Dynasylan® AMMO (Evonik®)), N-(2-aminoethyl)-3-aminopropyltrimethoxysilane (Geniosil® GF 9 or Geniosil® GF 91 (Wacker) or Dynasylan® DAMO (Evonik®), N-(n-butyl)aminopropyltrimethoxysilane (Dynasylan® 1189 (Evonik)), N-(2-aminoethyl)-3-aminopropylmethyldimethoxysilane (Geniosil® GF 95 (Wacker), Dynasylan® 1401 (Evonik®)). However, the adhesion promoters used are preferably, more preferably exclusively, ethanol-eliminating aminosilanes. Examples of adhesion promoters present with preference include 3-aminopropyltriethoxysilane (Geniosil® GF 93 (Wacker), Silquest® A-1100 and Silquest® A-1102 (Momentive Performance Materials); Dynasylan® AMEO (Evonik®)) and/or (3-aminopropyl)methyldiethoxysilane (Dynasylan® 1505 (Evonik®)), more preferably 3-aminopropyltriethoxysilane.

The proportion of the adhesion promoters, especially of those which eliminate exclusively ethanol as the alcohol, in the inventive composition is preferably from greater than 0 to 3.0% by weight, more preferably from 0.7 to 2.5% by weight and especially preferably from 1.0 to 2.0% by weight, based on the overall composition.

It may be advantageous when the inventive composition comprises a drying agent, for example for binding of water or moisture introduced by formulation components, or introduced subsequently by the dispensing operation or storage. The drying agents used in the inventive compositions may in principle be all drying agents known from the prior art. Preference is given to using chemical moisture drying agents, also called water scavengers. The chemical drying agent used may, for example, be vinyltrimethoxysilane (Dynasylan® VTMO, Evonik® or Geniosil® XL 10, Wacker®). Preference is given to using exclusively drying agents which, if they release alcohol in the drying operation, release exclusively ethanol. As a chemical moisture drying agent, the inventive composition comprises preferably vinyltriethoxysilane, which is obtainable, for example, under the Dynasylan® VTEO name, from Evonik® Degussa GmbH, as Silquest® A-151NT from Momentive Performance Materials, or as Geniosil® GF 56 from Wacker.

The proportion of the drying agents in the inventive composition is preferably from greater than 0 to 5% by weight, more preferably from 0.2 to 3% by weight, based on the overall composition.

The inventive composition may comprise one or more additives selected from the group of the plasticizers, fillers, solvents and additives for adjusting the flow characteristics (rheology additives).

The plasticizers may be selected, for example, from the group of the phthalates, the polyesters, alkylsulphonic esters of phenol, cyclohexanedicarboxylic esters, or else the polyethers. The plasticizers used are only those compounds other than the alkoxylation products A.

When plasticizers are present in the inventive composition, the proportion of the plasticizers in the inventive composition is preferably from greater than 0% by weight to 90% by weight, more preferably 2% by weight to 70% by weight, especially preferably 5% by weight to 30% by weight, based on the overall composition.

The fillers used may, for example, be precipitated or ground chalk, inorganic carbonates in general, precipitated or ground silicates, precipitated or fumed silicas, glass powders, hollow glass beads (called bubbles), metal oxides, for example TiO₂, Al₂O₃, natural or precipitated barium sulphates, reinforcing fibres, such as glass fibres or carbon fibres, long or short wollastonite fibres, cork, carbon black or graphite. It is advantageously possible to use hydrophobized fillers, since these products have a lower introduction of water and improve the storage stability of the formulations.

When fillers are present in the inventive composition, the proportion of the fillers in the inventive composition is preferably from 1 to 65% by weight, based on the overall composition, particular preference being given to concentrations of 30 to 65% by weight for the fillers specified here with the exception of the fumed silicas. When fumed silicas are used, a proportion of the fumed silicas of 5 to 18% by weight is particularly preferred.

The rheology additives selected, preferably present in addition to the filler, may be from the group of the amide waxes, to be purchased, for example, from Cray Valley under the Crayvallac® brand name, hydrogenated vegetable oils and fats, fumed silicas, for example Aerosil® R202 or R805 (both to be purchased from Evonik) or Cab-O-Sil® TS 720 or TS 620 or TS 630 (Cabot). When fumed silicas are already being used as a filler, the addition of a rheology additive can be dispensed with.

When rheology additives are present in the inventive composition, the proportion of the rheology additives in the inventive composition, according to the desired flow characteristics, is preferably from greater than 0% by weight to 10% by weight, more preferably from 2% by weight to 5% by weight, based on the overall composition.

Preferred solvents are those liquids which are free of methanol and which have preferably <0.05% by weight, based on the solvent, of water. Examples of solvents used may include toluene, tetrahydrofuran, dimethyl sulphoxide, dimethylformamide, ethanol and isopropanol. Preference is given to using toluene, dimethyl sulphoxide or tetrahydrofuran, particular preference to using tetrahydrofuran, as the solvent.

If required, the inventive compositions may also comprise one or more substances selected from the group comprising co-crosslinkers, flame retardants, deaerators, antimicrobial and preservative substances, dyes, colorants and pigments, antifreezes, fungicides and/or reactive diluents, and complexing agents, spraying aids, wetting agents, fragrances, light stabilizers, free-radical scavengers, UV absorbers and stabilizers, especially stabilizers against thermal and/or chemical stresses and/or stresses resulting from ultraviolet and visible light.

The UV stabilizers used may, for example, be known products based on hindered phenolic systems. The light stabilizers used may, for example, be what are called HALS amines. The stabilizers used may, for example, be the products known to those skilled in the art, or product combinations of, for example, Tinuvin® stabilizers (Ciba), preferably Tinuvin® 1130 in combination with Tinuvin® 292. The amount thereof used is guided by the degree of stabilization required.

Preferred inventive compositions comprise at least one alkoxylation product A, a plasticizer, a filler, an adhesion promoter, a drying agent and a (curing) catalyst.

Particularly preferred inventive compositions comprise from 10 to 80% by weight or less than 80% by weight, preferably from 21 to 75% by weight, based on the overall composition, of at least one prepolymer (alkoxylation product A) having an average of between 2.0 and 8.0 ethoxysilyl functions per prepolymer, from 0.3% by weight to 3.0% by weight, preferably from 0.5% by weight to 2.5% by weight and especially preferably from 0.70% by weight to 2.0% by weight, based on the overall composition, of at least one adhesion promoter, less than 30% by weight, preferably from 0.1 to 25% by weight, based on the overall composition, of at least one plasticizer, the mass ratio of alkoxylation products A and plasticizers more preferably being less than 1.1 times the proportion of the alkoxylation product A, from 5 to 65% by weight, based on the overall composition, of fillers, from 0.2 to 3.0% by weight, based on the overall composition, of at least one drying agent, especially a chemical moisture drying agent, and from 0.1% by weight to 5.00% by weight, preferably 0.15 to 2.00% by weight and especially 0.2 to 0.75% by weight, based on the overall composition, of at least one curing catalyst. In the case of very particularly preferred compositions, the proportions of the formulation constituents mentioned are selected such that the sum total of the proportions adds up to 100% by weight.

The invention compositions may, for example, be sealants or adhesives, or be used for production of a sealant or adhesive.

The inventive composition, particularly the inventive composition thus obtained, cures within periods comparable to products commercially available and used industrially to date, and, if it has been applied in relatively thick layers, crosslinks very well even in depth. Flank adhesion and binding to various substrates, for example steel, aluminium, various plastics and mineral substrates, for example stone, concrete and mortar, is good.

The inventive composition is especially notable in that, in the course of moisture-induced curing thereof, the weight ratio between ethanol released and other alcohols, especially methanol, is greater than 10:1, preferably greater than 20:1 and more preferably 50:1 to 200:1, or the alcohol released is exclusively ethanol.

The inventive compositions can be used especially for reinforcing, levelling, modification, adhesive bonding, sealing and/or coating of substrates. Suitable substrates are, for example, particulate or flat substrates, in the construction industry or in motor vehicle construction, construction elements, components, metals, especially construction materials such as iron, steel, stainless steel and cast iron, ceramic materials, especially based on solid metal or nonmetal oxides or carbides, aluminium oxide, magnesium oxide or calcium oxide, mineral or organic substrates, especially cork and/or wood, mineral substrates, particleboards and fibreboards of wood or cork, composite materials, for example wood composites such as MDF boards (medium-density fibreboards), WPC (wood plastic composite) articles, particleboards, cork articles, laminated articles, ceramics, but also natural fibres and synthetic fibres (and substrates comprising them) or mixtures of different substrates. Particular preference is given to using the inventive compositions for sealing and/or coating of particulate or flat substrates, in the construction industry or in motor vehicle construction, for sealing and adhesive bonding of construction elements and components, and for coating of porous or nonporous, particulate or flat substrates, for coating and modification of surfaces and for uses on metals, especially on construction materials such as iron, steel, stainless steel and cast iron, for use on ceramic materials, especially based on solid metal or nonmetal oxides or carbides, aluminium oxide, magnesium oxide or calcium oxide, on mineral substrates or organic substrates, especially on cork and/or wood, for binding, reinforcing and levelling of uneven, porous or brittle substrates, for example mineral substrates, particleboards and fibreboards of wood or cork, composite materials, for example wood composites such as MDF boards (medium-density fibreboards), WPC (wood plastic composite) articles, particleboards, cork articles, laminated articles, ceramics, but also natural fibres and synthetic fibres, or mixtures of different substrates.

The examples adduced hereinafter describe the present invention by way of example, without any intention that the invention, the range of application of which is evident from all of the description and the claims, be restricted to the embodiments specified in the examples.

### Operative Examples

Inventive examples of curable compositions which eliminate exclusively ethanol in the course of curing are described hereinafter.

### Production of the Curable Composition:

The components of the composition (alkoxylation product, plasticizer, filler and rheology additive) were mixed vigorously with one another in a mixer (Speedmixer FVS 600, Hausschild). Subsequently, the rest of the components were added and mixed vigorously. It should be ensured that a temperature of 65° C. is not exceeded after the addition of the adhesion promoter. The finished formulation was transferred to Euro cartridges and stored before application at room temperature for a minimum of 24 h.

### Storage Test:

The compositions sealed air-tight in the cartridge were stored in a laboratory drying cabinet at a temperature of 60° C. If the material present in the cartridge could still be pressed efficiently out of the cartridge after 2 weeks by means of a conventional skeleton gun, also called a cartridge press, for sealants with manual operation, the storage stability was assessed as good.

### Curing Kinetics:

The curing rate was determined with the aid of a wedge-shaped coating bar manufactured from a Teflon block. The wedge countersunk into the block was filled with the curable composition and smoothed off to the level of the block edges. The result was thus a layer thickness distribution over the block length of the curable composition of 0 to 10 mm. The filled wedge was stored at 23° C. and 50% relative air humidity. After 24 hours, beginning from the thin end of the wedge, the cured composition was lifted off and the thickness of the cured layer was determined. The cured thickness was considered to be the thickness at which direct mechanical integrity with the cured surface still existed, without containing any liquid or jelly-like components.

### Analysis for Methanol and Ethanol:

A metal backing was painted with 4 g of the fresh uncured composition and placed in a 1 l PE bottle such that it rests obliquely in the bottle. About 5 ml of water were introduced into the bottom of the bottle such that direct contact between water and composition was avoided. The bottle was closed and stored at 23° C. for 48 h. After this time, 2 holes were punched in the lid and the constituents present in the bottle were transferred to silica gel-containing adsorber tubes with the aid of nitrogen, the volume of which corresponds to six times the bottle volume. The constituents collected in the adsorber tube were analysed by means of headspace gas chromatography. Calibration, sampling and analysis were effected by a method recognized for air analyses (DFG—Analytische Methoden zur Prüfung gesundheitsschadlicher Arbeitsstoffe [German Research Foundation—Analytical Methods for Testing of Working Materials Harmful to Health], Method No. 6, 11^{th} edition, 1997, Verlag Chemie (now: Wiley-VCH)).

### Production of the Tensile Specimens:

The composition to be examined was introduced into a coating bar with a gap width of 2 mm and coated onto a polyethylene film. After the curing of the bar-applied sheet, after 7 days at 23° C. and 50% relative air humidity, tensile specimens to DIN 53504-S2 were punched out of it with the aid of a cutting mould and a toggle press.

### Testing of the Tensile Specimens:

The thickness of the tensile specimens produced to DIN 53504-S2 was measured for each specimen before commencement of testing, in order to take account of the effective cross-sectional area. The tensile specimens were clamped in a roll clamp on a universal tester and tested at a pulling speed of 200 min/min.

### Production of the Tensile Shear Bonds:

The compositions were applied directly from the cartridge. 2 stainless steel substrates of V2A steel type (1.4301 (designation according to Key to Steel)), and in each case 2 aluminium substrates (AlMgSi7), which had been cleaned beforehand by soaking in fresh ethanol for 24 h and then wiping dry with adsorptive paper, and then dried, were used. Substrates with a width of 25 mm, a thickness of 2 mm and a length of 100 mm were used. The bonded area in all cases was 500 mm².

### Testing of the Tensile Shear Bonds:

After curing under standard climatic conditions (23° C. and 50% relative air humidity) for 10 days, the tensile shear bonds were clamped in a jaw clamp of a universal tester and pulled at 10 mm/min until fracture. The stress applied to the sample on fracture of the bond is noted.

### Example 1

### Production of Alkoxylation Product 1

A 5 litre autoclave was initially charged with 437 g of Desmophen® 2061 BD (Bayer MaterialScience), and 100 ppm (based on the overall mixture) of a zinc hexacyanocobaltate double metal cyanide catalyst was added. For inertization, the reactor was charged with nitrogen up to 3 bar and then decompressed to standard pressure. The operation was repeated twice more. The reactor contents were heated to 130° C. while stirring and evacuated to approx. 20 mbar in order to remove volatile components. After 30 min, the catalyst was activated by metering 60 g of propylene oxide into the evacuated reactor. The internal pressure rose initially to approx. 0.6 bar. After approx. 15 min, the reaction set in, which was noticeable by a decline in the reactor pressure. Then 790 g of propylene oxide was metered in continuously within half an hour. Reaction continued for one hour, during which the temperature was lowered to 85° C. At this temperature and maximum cooling performance, a mixture of 238 g of 3-glycidyloxypropyltriethoxysilane (Dynasylae® GLYEO®, from Evonik Degussa GmbH) and 1476 g of propylene oxide was added continuously such that the temperature remained constant. Continued reaction for another hour was followed by deodorization by applying a vacuum (pressure <100 mbar) in order to remove residues of unconverted alkylene oxide, and introduction of 500 ppm of Irganox® 1135 (from BASF) as an antioxidant by stirring for 15 minutes. This gave a colourless, high-viscosity product with a viscosity of 7-9 Pa*s at 25° C. (MCR 301 rheometer, Anton Paar) and a shear rate of 10 l/s. The resulting product was admixed with 0.1% by weight of a bismuth catalyst (TIB® KAT 720, TIB Chemicals) and heated to 70° C. On attainment of the temperature, 0.7% by weight of n-butyl isocyanate, based on the product of the above alkoxylation, was added and the reaction mixture was mixed vigorously for a further 4 hours and then cooled.

TABLE 1
Formulation 1.1

| | Proportion |
|---|---|
| Constituent | by mass |
| Alkoxylation product according to Example 1 | 22.2% by wt. |
| Diisoundecylene phthalate (plasticizer) | 21.0% by wt. |
| Socal ® U1S2 (filler) | 49.5% by wt. |
| Vinyltriethoxysilane (Dynasylan ® VTEO, EVONIK ®) | 1.0% by wt. |
| Ethoxy-functional aminosilane [Dynasylan ® AMEO] | 1.5% by wt. |
| (adhesion promoter) | |
| Amide wax [Crayvallac ® SLX] (rheology additive) | 3.5% by wt. |
| Tinuvin ® 292 (stabilizer) | 0.5% by wt. |
| Tinuvin ® 1130 (stabilizer) | 0.5% by wt. |
| Dioctyltin diketonate [TIB ® KAT 223] (catalyst) | 0.3% by wt. |

TABLE 2
Formulation 1.2

| | Proportion |
|---|---|
| Constituent | by mass |
| Alkoxylation product according to Example 1 | 22.2% by wt. |
| Diisononyl phthalate DINP (plasticizer) | 21.0% by wt. |
| Silbond ® 800 AST(filler) | 49.5% by wt. |
| Vinyltriethoxysilane (Dynasylan ® VTEO, EVONIK ®) | 1.0% by wt. |
| Ethoxy-functional aminosilane [Dynasylan ® AMEO] | 1.2% by wt. |
| (adhesion promoter) | |
| Amide wax [Crayvallac ® SLX] (rheology additive) | 4.0% by wt. |
| Tinuvin ® 292 (stabilizer) | 0.75% by wt. |
| Tinuvin ® 1130 (stabilizer) | 0.75% by wt. |
| Dioctyltin diketonate [TIB ® KAT 223] (catalyst) | 0.4% by wt. |

### Example 2

### Preparation of Alkoxylation Product 2

A 5 litre autoclave was initially charged with 102 g of Acclaim® 8200 (Bayer MaterialScience), and 150 ppm (based on the overall mixture) of a zinc hexacyanocobaltate double metal cyanide catalyst was added. For inertization, the reactor was charged with nitrogen up to 3 bar and then decompressed to standard pressure. The operation was repeated twice more. The reactor contents were heated to 130° C. while stiffing and evacuated to approx. 20 mbar in order to remove volatile components. After 30 min, the catalyst was activated by metering 60 g of propylene oxide into the evacuated reactor. The internal pressure rose initially to approx. 0.6 bar. After approx. 15 min, the reaction set in, which was noticeable by a decline in the reactor pressure. Then 835 g of propylene oxide was metered in continuously within half an hour. Reaction continued for one hour, during which the temperature was lowered to 85° C. At this temperature, a mixture of 142 g of 3-glycidyloxypropyltriethoxysilane (Dynasylan® GLYEO, from Evonik Degussa GmbH) and 1008 g of propylene oxide was added continuously such that the temperature remained constant. Continued reaction for another hour was followed by deodorization by applying a vacuum (pressure <100 mbar) in order to remove residues of unconverted alkylene oxide, and introduction of 500 ppm of Irgano® 1135 (from BASF) as an antioxidant by stirring for 15 minutes. This gave a colourless, high-viscosity product with a viscosity of 16-19 Pa*s at 25° C. (MCR 301 rheometer, Anton Paar) and a shear rate of 10 l/s. The resulting alkoxylation product was admixed with 0.1% by weight of a bismuth catalyst (TIB® KAT 720, TIB Chemicals) and heated to 70° C. On attainment of the temperature, 0.7% by weight of n-butyl isocyanate, based on the aforementioned alkoxylation product, was added and the reaction mixture was mixed vigorously for a further 4 hours and then cooled.

TABLE 3
Formulation 2.1:

| | Proportion |
|---|---|
| Component | by mass |
| Alkoxylation product according to Example 2 | 22.2% by wt. |
| Diisoundecylene phthalate (plasticizer) | 21.0% by wt. |
| Socal ® U1S2 (filler) | 49.5% by wt. |
| Vinyltriethoxysilane (Dynasylan ® VTEO, EVONIK ®) | 1.0% by wt. |
| Ethoxy-functional aminosilane [Dynasylan ® AMEO] | 1.5% by wt. |
| (adhesion promoter) | |
| Amide wax [Crayvallac ® SLX] (rheology additive) | 3.5% by wt. |
| Tinuvin ® 292 (stabilizer) | 0.5% by wt. |
| Tinuvin ® 1130 (stabilizer) | 0.5% by wt. |
| Dioctyltin diketonate [TIB ® KAT 223] (catalyst) | 0.3% by wt. |

TABLE 4
Formulation 2.2:

| | Proportion |
|---|---|
| Component | by mass |
| Alkoxylation product according to Example 2 | 22.2% by wt. |
| Diisononyl phthalate (plasticizer) | 21.0% by wt. |
| Silbond ® 800 AST(filler) | 49.5% by wt. |
| Vinyltriethoxysilane (Dynasylan ® VTEO, EVONIK ®) | 1.0% by wt. |
| Ethoxy-functional aminosilane [Dynasylan ® AMEO] | 1.5% by wt. |
| (adhesion promoter) | |
| Amide wax [Crayvallac ® SLX] (rheology additive) | 3.5% by wt. |
| Tinuvin ® 292 (stabilizer) | 0.5% by wt. |
| Tinuvin ® 1130 (stabilizer) | 0.5% by wt. |
| Dioctyltin diketonate [TIB ® KAT 223] (catalyst) | 0.3% by wt. |

TABLE 5
Formulation 2.3:

| | Proportion |
|---|---|
| Component | by mass |
| Alkoxylation product according to Example 2 | 65.0% by wt. |
| Diisoundecylene phthalate (plasticizer) | 22.4% by wt. |
| Fumed silica (Aerosil ® R805, EVONIK, filler and | 8.0% by wt. |
| rheology additive) | |
| Vinyltriethoxysilane (Dynasylan ® VTEO, EVONIK ®) | 2.0% by wt. |
| Ethoxy-functional aminosilane [Dynasylan ® AMEO] | 1.7% by wt. |
| (adhesion promoter) | |
| Tinuvin ® 292 + Tinuvin ® 1130 (ratio 1:1) (stabilizers) | 0.5% by wt. |
| Dioctyltin diketonate [TIB ® KAT 223] (catalyst) | 0.4% by wt. |

### Comparative Example 1

For comparison, a composition of the components according to Table 6 was formulated.

TABLE 6
Comparative formulation 1 (commercial product comparison):

| | Proportion |
|---|---|
| Component | by mass |
| Kaneka MS ® polymer S203H/S303H (60/40) | 24.4% by wt. |
| Diisononyl phthalate DINP (plasticizer) | 14.0% by wt. |
| Socal ® U1S2 (filler) | 55.0% by wt. |
| Vinyltriethoxysilane (Dynasylan ® VTEO, EVONIK ®) | 1.0% by wt. |
| Ethoxy-functional aminosilane [Dynasylan ® AMEO] | 1.7% by wt. |
| (adhesion promoter) | |
| Fumed silica (Aerosil ® R202, EVONIK, rheology | 3.0% by wt. |
| additive) | |
| Tinuvin ® 292 (stabilizer) | 0.25% by wt. |
| Tinuvin ® 1130 (stabilizer) | 0.25% by wt. |
| Dioctyltin diketonate [TIB ® KAT 223] (catalyst) | 0.4% by wt. |

### Comparative Example 2

For comparison with the currently customary formulation method, the composition listed in comparative example 1 was formulated with a likewise methanol-releasing polymer, Desmoseal® S XP 2636 (Bayer), and the widespread methanol-releasing constituents Dynasylan® AMMO (methoxy-functional aminosilane, EVONIK) instead of the ethoxy-functional aminosilane, and Dynasylan® VTMO (methoxy-functional drying agent) instead of Dynasylan® VTEO. The proportions in the formulation remained unchanged.

Table 7 below lists the alcohols released and determined by the process described above.

TABLE 7
Comparison of the alcohols released into the test
atmosphere in the course of curing within 48 h.

| | Example | Example | Example | Example | Example | Comp. | Comp. |
|---|---|---|---|---|---|---|---|
| | 1.1 | 1.2 | 2.1 | 2.2 | 2.3 | Ex. 1 | Ex. 2 |
| Methanol [mg] | <0.02 | <0.02 | <0.02 | <0.02 | <0.02 | 0.84 | 5.61 |
| Ethanol [mg] | 8.0 | 8.0 | 4.8 | 6.8 | 10.5 | 7.5 | <0.02 |

As shown in Table 7, there is no significant release of methanol (<0.02 mg) into the test atmosphere in the course of curing of the inventive formulations. Only ethanol is found in significant amounts. In comparative example 1, in contrast, increased amounts of methanol are found, at least 42 times the amount compared to the inventive formulations. Comparative example 2 is used to represent a formulation with exclusively methoxysilane-functionalized polymer, drying agent and adhesion promoter. Here, an increased amount of methanol in contrast to the inventive examples is clearly found.

On comparison of the curing depth after 24 h, it was found that, surprisingly, the curing depth achieved for the similar formulations 1.2 and comparative example 1 differs only by a few fractions of a millimetre. For inventive formulation 1.2, a curing depth of 3.5 mm was measured after 24 h; within the same time, a depth of 3.8 mm was attained in comparative example 1. Formulations 1.1 and 2.2 even achieve a depth of 3.8 to 4.0 mm within 24 h. However, due to the alteration in the polymer and plasticizer content compared to the comparative formulation, these are only of limited comparability.

TABLE 8
Mechanical characteristics of the formulations shown in the working and comparative examples
after curing thereof under standard climatic conditions (T: 23° C., 50% RAH):

| | | Example | Example | Example | Example | Example | Comp. |
|---|---|---|---|---|---|---|---|
| | | 1.1 | 1.2 | 2.1 | 2.2 | 2.3 | Ex. 1 |
| Tensile | Breaking stress | 0.63 | 1.29 | 0.20 | 0.59 | 0.14 | 1.68 |
| specimen | [MPa] | | | | | | |
| | Elongation at | 67 | 43 | 120 | 78 | 78 | 177 |
| | break [%] | | | | | | |
| Bonds to | Breaking stress | 1.83 | 1.76 | 0.51 | 0.51 | 0.27 | 2.04 |
| V2A steel | [MPa] | | | | | | |
| | Fracture | CF | CF | CF | AF | AF | CFS |
| | characteristics | | | | | | |
| Bonds to | Breaking stress | 1.64 | 1.33 | 0.37 | 0.26 | 0.32 | 1.22 |
| aluminium | [MPa] | | | | | | |
| | Fracture | CF | MF | MF | AF | AF | AF |
| | characteristics | | | | | | |

(Designation of the fracture characteristics: CF = cohesion fracture, AF = adhesion fracture, CFS = cohesion fracture close to surface, MF = mixed adhesion/cohesion fracture).

As shown in Table 8, the inventive compositions possess good adhesion capacity and stress and strain characteristics suitable for a multitude of applications.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. Curable composition comprising at least one nonexclusively terminally alkoxysilylated alkoxylation product, at least one curing catalyst, characterized in that the nonexclusively terminally alkoxysilylated alkoxylation product is a prepolymer having an average of between 2.0 and 8.0 ethoxysilyl functions per prepolymer.

2. Composition according to claim 1, characterized in that the nonexclusively terminally alkoxysilylated alkoxylation product has exclusively ethoxysilyl groups as the alkoxysilyl group.

3. Composition according to claim 1 or 2, characterized in that all ethoxysilyl groups are triethoxysilyl groups.

4. Composition according to any of claims 1 to 3, characterized in that the nonexclusively terminally alkoxysilylated alkoxylation product is a prepolymer of the general formula (III) 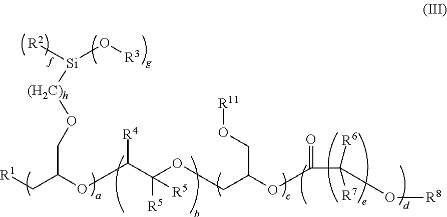
where
R¹=a mono- to hexafunctional saturated or unsaturated, linear or branched organic radical of the alkoxy, arylalkoxy or alkylarylalkoxy group type, in which the carbon chain may be interrupted by oxygen atoms and may also bear pendant substituents containing alkoxysilyl groups or is substituted directly by alkoxysilyl groups, selected from the group of the polyoxyalkylene radicals, polyether radicals, a polyetheralkoxy radical
or is a singly or multiply fused phenolic group,
or may be derived from a mono- or polyhydroxylated alcohol, polyetherol, polyesterol, siloxane, perfluorinated polyetherol, (poly)urethane or sugar,
R²=an alkyl group having 1 to 2 carbon atoms,
R³=an alkyl group having 2 carbon atoms,
R⁴=independently a hydrogen radical or an alkyl group having 1 to 8 carbon atoms,
R⁵=independently a hydrogen radical, an alkyl group having 1 to 20 carbon atoms, an aryl or alkaryl group,
R⁶ and R⁷=independently as R⁵,
R⁸=a trialkylsilyl end block or a urethane end block or ester end block which has originated from the reaction of a terminal alcohol function with hydroxyl-reactive compounds containing the R⁸ radical, especially an end group of the formula (IV) 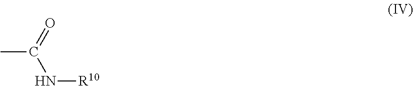
where
R¹⁰=independently a linear or branched, saturated or unsaturated, optionally further-substituted alkyl group having 1 to 30 carbon atoms, an aryl or alkaryl group or an -A(T)ₓ group where A=hydrocarbyl radical which may optionally be substituted by halogen atoms, x=1 to 4, and T is the same or different and is —N═C═O, —NH—C(O)—X, where X=O—R¹² or NH—R¹², where R¹² is the same or different and is a hydrocarbyl radical which may be interrupted by heteroatoms, or X is a radical of the formula (IIIa) 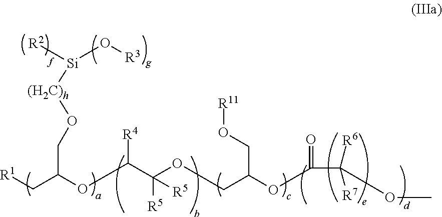
a=0 to 1000, with the proviso that a must be greater than or equal to 2 when R¹ does not bear any substituents with alkoxysilyl groups or is not itself directly substituted by alkoxysilyl groups,
b=0 to 1000,
c=independently as b,
d=independently as b,
and the sum of the fragments with the indices a, b, c and d is at least 3,
with the proviso that the groups with the indices a, b, c and d are freely permutable over the molecule chain, but at least more than one group with the index a is not arranged terminally in the polymer chain,
e=1 to 10,
g+f=3 and g is at least equal to 2,
h=2, 3, 4, and with the proviso that
the different monomer units both of the fragments with the indices a, b, c, and d and of the polyoxyalkylene chain of the R¹ substituent may be in blockwise structure with one another, or else may be subject to a random distribution, and are additionally freely permutable with one another.

5. Composition according to claim 4, characterized in that the composition comprises exclusively prepolymers of the formula (III) where R⁸ is as defined in claim 4 and no prepolymers of the formula (III) in which R⁸ is hydrogen.

6. Composition according to claim 4, characterized in that the composition, as well as prepolymers of the formula (III) where R⁸ is as defined in claim 4, also comprises those prepolymers of the formula (III) in which R⁸ is hydrogen.

7. Composition according to claim 6, characterized in that the mass ratio of prepolymers of the formula (III) where R⁸ is as defined in claim 4 to prepolymers of the formula (III) in which R⁸ is hydrogen is from 100:>0 to 10:90.

8. Composition according to at least one of claims 1 to 7, characterized in that the composition comprises one or more adhesion promoters and/or one or more chemical moisture drying agents.

9. Composition according to at least one of claims 1 to 8, characterized in that it comprises, as an adhesion promoter, 3-aminopropyltriethoxysilane and/or (3-aminopropyl)methyldiethoxysilane.

10. Composition according to at least one of claims 1 to 9, characterized in that it comprises, as a chemical moisture drying agent, vinyltriethoxysilane.

11. Composition according to at least one of claims 1 to 10, characterized in that the composition comprises one or more additives selected from the group of the plasticizers, fillers, solvents and additives for adjusting the flow characteristics.

12. Composition according to at least one of claims 1 to 11, characterized in that it comprises one or more substances selected from the group comprising co-crosslinkers, flame retardants, deaerators, antimicrobial and preservative substances, dyes, colorants and pigments, antifreezes, fungicides and/or reactive diluents, and complexing agents, spraying aids, wetting agents, fragrances, light stabilizers, free-radical scavengers, UV absorbers and stabilizers.

13. Composition according to at least one of claims 1 to 12, characterized in that the composition is a sealant or adhesive or is used for production of a sealant or adhesive.

14. Composition according to at least one of claims 1 to 13, characterized in that the composition comprises 10 to less than 80% by weight, based on the overall composition of prepolymer having an average of between 2.0 and 8.0 ethoxysilyl functions per prepolymer.

15. Composition according to any of claims 1 to 14, characterized in that the composition comprises from 10 to 80% by weight, based on the overall composition of prepolymer having an average of between 2.0 and 8.0 ethoxysilyl functions per prepolymer, of adhesion promoter with a proportion of 0.3% by weight to 3.0% by weight, plasticizer with a proportion of less than 30% by weight, the mass ratio of curable alkoxylation product and plasticizer more preferably being less than 1.1 times the alkoxylation product, fillers with a proportion of 18 to 65% by weight, chemical moisture drying agents with a proportion of 0.2 to 3.0% by weight, and curing catalysts with a proportion of 0.1 to 5.00% by weight, based in each case on the overall composition.

16. Composition according to any of the preceding claims, characterized in that, in the course of moisture-induced curing, the weight ratio between ethanol released and other alcohols, especially methanol, is greater than 10:1, or the alcohol released is exclusively ethanol.

17. Use of curable compositions according to at least one of claims 1 to 16 for reinforcement, levelling, modification, adhesive bonding, sealing and/or coating of substrates.
